(19) United States
(12) Patent Application Publication
(10) Pub. No.: US 2025/0015301 A1
(43) Pub. Date: Jan. 9, 2025

(54) SOLID-STATE BATTERY

(71) Applicants: TOYOTA JIDOSHA KABUSHIKI KAISHA, Toyota-shi (JP); Aisan Kogyo Kabushiki Kaisya, Obu-shi (JP)

(72) Inventors: Takuya MATSUYAMA, Susono-shi (JP); Kazuki TAGA, Nagoya-shi (JP)

(73) Assignees: TOYOTA JIDOSHA KABUSHIKI KAISHA, Toyota-shi (JP); Aisan Kogyo Kabushiki Kaisya, Obu-shi (JP)

(21) Appl. No.: 18/762,243

(22) Filed: Jul. 2, 2024

(30) Foreign Application Priority Data
Jul. 4, 2023 (JP) 2023-110339

(51) Int. Cl. H01M 4/66; H01M 4/02; H01M 4/134; H01M 4/38

(52) U.S. Cl. CPC H01M 4/663; H01M 4/134; H01M 4/386; H01M 4/668; H01M 2004/027

(57) ABSTRACT

A solid-state battery includes an electrode. The electrode includes a resin current collector including a resin, a spherical carbon material, and a fibrous carbon material and an active material layer including an active material.

### CROSS-REFERENCE TO RELATED APPLICATION

This application is based on and claims priority under 35 USC 119 from Japanese Patent Application No. 2023-110339, filed on Jul. 4, 2023, the disclosure of which is incorporated by reference herein.

### BACKGROUND

### Technical Field

The present disclosure relates to a solid-state battery.

### Related Art

In recent years, secondary batteries such as lithium-ion secondary batteries have been suitably used as portable power sources for personal computers and mobile devices and as power sources for driving vehicles such as battery electric vehicles (BEV), hybrid electric vehicles (HEV), and plug-in hybrid electric vehicles (PHEV).

Secondary batteries use an electrolyte solution including a flammable organic solvent, so it is necessary to install a safety device to keep the temperature of the battery from rising in the event of a short-circuit and to improve structures and materials for preventing short-circuits. In contrast, solid-state batteries, in which the electrolyte solution is replaced with a solid-state electrolyte layer so that the material is solidified, do not use a flammable organic solvent inside the battery, so the safety device can be simplified and the batteries are considered to have excellent properties with respect to manufacturing costs and productivity.

Current collectors in conventional solid-state batteries employ a single-layer structure formed of a ceramic foil or a metal foil or a laminated body including a ceramic foil and a metal foil (e.g., Japanese Patent Application Laid-open (JP-A) No. 2017-112029).

### SUMMARY

However, in conventional solid-state batteries equipped with current collectors including a ceramic foil and/or a metal foil, when the active material layer expands or contracts due to a sudden increase or a release of the active material during the charge-discharge process, the ion conduction path and the electron conduction path tend to be severed, and the capacity retention rate tends to become lower. In JP-A No. 2017-112029, in order to inhibit delamination of the active material layer, confining pressure is applied by securing the solid-state battery with a restraint jig, but a large restraint jig is needed to apply a high confining pressure, and so there is room for improvement.

Thus, in view of the above circumstances, the present disclosure addresses provision of a solid-state battery in which a reduction in discharge capacity is curbed.

Aspects according to the present disclosure for providing such a solid-state battery include the following aspects.

<1> A solid-state battery, comprising an electrode, the electrode including:
a resin current collector including a resin, a spherical carbon material, and a fibrous carbon material; and
an active material layer including an active material.
   <2> The solid-state battery according to <1>, wherein the active material includes an Si-based active material.
   <3> The solid-state battery according to <1> or <2>, wherein the softening temperature of the resin is from 30° C. to 80° C.
   <4> The solid-state battery according to any one of <1> to <3>, wherein the spherical carbon material includes acetylene black (AB), and the content of the spherical carbon material is from 2% by mass to 13% by mass relative to the total solid content of the resin current collector.
   <5> The solid-state battery according to any one of <1> to <4>, wherein the fibrous carbon material includes vapor-grown carbon fiber (VGCF), and the content of the fibrous carbon material is from 15% by mass to 25% by mass relative to the total solid content of the resin current collector.

According to the present disclosure, a solid-state battery in which a reduction in discharge capacity is curbed is provided.

### BRIEF DESCRIPTION OF THE DRAWINGS

FIG. 1 is a schematic cross-sectional view showing an embodiment of a solid-state battery of the present disclosure;

FIG. 2 is a graph showing the relationship between confining pressure change indices and charging amounts in Example 1 and Comparative Example 1;

FIG. 3 is a graph showing the relationship between discharge capacity and the number of charge-discharge cycles in Example 1 and Comparative Example 1; and

FIG. 4 is a graph showing relative resistance values in solid-state batteries of Examples 1 to 4 and Comparative Example 1.

### DETAILED DESCRIPTION

An embodiment that is an example of the present disclosure will be described below. These descriptions and Examples are intended to exemplify the embodiment and are not intended to limit the scope of the present disclosure.

In the present disclosure, a numerical range expressed using “to” means a range including the numerical values appearing before and after the “to” as a lower limit and an upper limit, respectively.

Regarding numerical ranges that are progressively described in the present disclosure, the upper limit or the lower limit described in one numerical range may be replaced with the upper limit or the lower limit of another progressively described numerical range. Furthermore, regarding numerical ranges described in the present disclosure, the upper limits or the lower limits of those numerical ranges may be replaced with values described in the Examples.

In the present disclosure, when there are more than one substances that correspond to a component of interest in a composition, the amount of the component in the composition means the total amount of those plural substances in the composition unless otherwise specified.

In the present disclosure, combinations of two or more preferred aspects are more preferred aspects.

In the present disclosure, the scope of the term “layer” includes not only cases where, when a region in which the layer is present is observed, the layer is formed on the entire region but also cases where the layer is formed only on part of the region.

In the present disclosure, the scope of the term “step” includes not only an independent step but also a step that cannot be clearly distinguished from another step as long as the intended object of the step is achieved.

### —Solid-State Battery—

The solid-state battery according to the present disclosure includes an electrode, the electrode including a resin current collector including a resin, a spherical carbon material, and a fibrous carbon material and an active material layer including an active material.

According to the present disclosure, a reduction in discharge capacity (e.g., capacity retention rate after 150 cycles) is curbed. Although the mechanism of action is not completely clear, but we surmise that the mechanism of action is as follows.

The solid-state battery according to the present disclosure includes a resin current collector. For that reason, compared with a case where the current collector is a metal foil, the resin current collector easily absorbs internal stress accompanying expansion of the electrode, and pressure acting on the solid-state battery is reduced. Moreover, the resin current collector includes, in addition to a resin, a spherical carbon material and a fibrous carbon material. For that reason, even if tiny cracks due to changes in volume occur in the active material layer provided on the current collector, a reduction in discharge capacity is curbed because the spherical carbon material and the fibrous carbon material connect conduction paths.

Hereinafter, the electrode including a resin current collector including a resin, a spherical carbon material, and a fibrous carbon material and an active material layer including an active material will be referred to as “the specific electrode.”

The solid-state battery of the present disclosure includes what is called an all-solid-state battery which uses a solid-state electrolyte as the electrolyte, and the solid-state electrolyte may include an electrolyte solution in an amount that is less than 10% by mass relative to the total amount of the electrolyte. It will be noted that the solid-state electrolyte may be a composite solid-state electrolyte including an inorganic solid-state electrolyte and a polymer electrolyte.

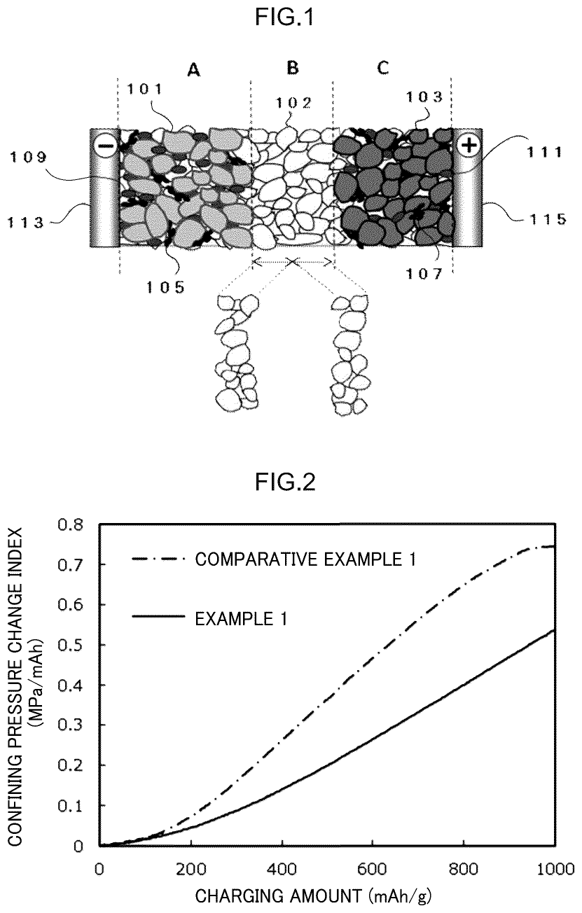

An example of the solid-state battery of the present disclosure will now be described with reference to the drawings. FIG. 1 is a schematic cross-sectional view showing an example of the solid-state battery of the present disclosure. The solid-state battery shown in FIG. 1 includes a negative electrode including a negative electrode current collector 113 and a negative electrode active material layer A, a solid-state electrolyte layer B, and a positive electrode including a positive electrode current collector 115 and a positive electrode active material layer C. The negative electrode active material layer A includes a negative electrode active material 101, a conductive aid 105, a binder 109, and a solid-state electrolyte 102. The positive electrode active material layer C includes a positive electrode active material 103, a conductive aid 107, a binder 111, and the solid-state electrolyte 102. The solid-state electrolyte layer B may be a single layer or have a two-layer structure.

The solid-state battery shown in FIG. 1 includes the specific electrode as at least one of the negative electrode or the positive electrode. When the negative electrode is configured to be the specific electrode, the negative electrode current collector 113 is a resin current collector including a resin, a spherical carbon material, and a fibrous carbon material. When the positive electrode is configured to be the specific electrode, the positive electrode current collector 115 is a resin current collector including a resin, a spherical carbon material, and a fibrous carbon material.

When a set of the positive electrode, the solid-state electrolyte layer, and the negative electrode serves as a power generation unit, the solid-state battery may include just one power generation unit or may include two or more power generation units. When the solid-state battery includes two or more power generation units, the power generation units may be connected in series or may be connected in parallel.

When the solid-state battery includes two or more power generation units (i.e., when the solid-state battery is a stacked-cell battery), at least one positive electrode or negative electrode is configured to be the specific electrode. From the standpoint of further curbing a reduction in discharge capacity, the electrode positioned between the respective units in the stacked structure (e.g., in the case of monopolar structure, the portion represented by “positive electrode active material layer/current collector/positive electrode active material layer” and/or the “negative electrode active material layer/current collector/negative electrode active material layer” in a stacked-cell battery including the layered structure of “negative electrode active material layer/current collector/negative electrode active material layer/solid-state electrolyte layer/positive electrode active material layer/current collector/positive electrode active material layer”, and in the case of a bipolar structure, the portion represented by “positive electrode active material layer/current collector” and/or the “current collector/negative electrode active material layer” in a stacked-cell battery including the layered structure of “negative electrode active material layer/current collector/positive electrode active material layer/solid-state electrolyte layer/negative electrode active material layer/current collector/positive electrode active material layer”) is preferably configured to be the specific electrode, and it is preferable that the electrodes in all the power generation units are each configured to be the specific electrode.

In the solid-state battery, layer-stack edges (i.e., side faces) of the stacked structure of positive electrode/solid-state electrolyte layer/negative electrode may be sealed with a sealing material such as resin. The negative electrode current collector 113 and the positive electrode current collector 115 may each be configured to have a buffer layer, an elastic layer, or a positive temperature coefficient (PTC) thermistor layer disposed on an outer peripheral surface thereof.

The shape of the solid-state battery is not particularly limited, and the solid-state battery may for example be a coin-type, a cylindrical-type, a prismatic-type, a sheet-type, a button-type, a flat-type, or a stacked-type.

### <Specific Electrode>

The specific electrode is an electrode that includes (i) a resin current collector including a resin, a spherical carbon material, and a fibrous carbon material and (ii) an active material layer including an active material.

The solid-state battery according to the present disclosure includes the specific electrode as at least one of a negative electrode or a positive electrode. In the solid-state battery according to the present disclosure, it is preferable that at least a negative electrode is configured to be the specific electrode, and it is more preferable that each of a negative electrode and a positive electrode is configured to be the specific electrode, from the standpoint of further curbing a reduction in discharge capacity for example.

### [Resin Current Collector]

The resin current collector includes a resin, a spherical carbon material, and a fibrous carbon material.

Examples of the resin include known thermoplastic resins such as poly(meth)acrylic acid, polymethyl (meth)acrylate, polyethylene, polypropylene, polyethylene terephthalate, polyether nitrile, polyimide, polyamide, polytetrafluoroethylene, polyacrylonitrile, poly(meth)acrylate, and halogenated vinyl resins; known thermosetting resins such as epoxy resins, vinyl ester resins, unsaturated polyester resins, phenolic resins, and melamine resin; and known electrically conductive polymers such as polyaniline, polypyrrole, polythiophene, polyacetylene, polyparaphenylene, polyphenylene vinylene, polyacrylonitrile, and polyoxadiazole. One resin may be used singly, or two or more resins may be used in combination.

Among the above, from the standpoint of further curbing a reduction in discharge capacity due to delamination of the active material layer from the resin current collector, the resin preferably includes at least one of a thermoplastic resin or an electrically conductive polymer, more preferably includes a thermoplastic resin, and even more preferably includes one resin selected from the group consisting of polymethyl (meth)acrylate, polyacrylic acid, and polyacrylonitrile.

In the present disclosure, “(meth)acrylic acid” is a concept encompassing both acrylic acid and methacrylic acid, and “(meth)acrylate” is a concept encompassing both acrylates and methacrylates.

The resin may be a crystalline resin, an amorphous resin, or a mixture of both, and is preferably an amorphous resin from the standpoint of enhancing strength and further curbing a reduction in discharge capacity due to delamination of the active material layer from the resin current collector. It will be noted that the “crystallinity” of a resin refers to having an endothermic peak with a half-width of 10° C. or less when measured at a temperature increase rate of 10 (° C./min) in differential scanning calorimetry (DSC). The “amorphousness” of a resin means that the half-width exceeds 10° C. or that no clear endothermic peak is observed.

The softening temperature of the resin varies with each resin, but from the standpoint of further curbing a reduction in discharge capacity due to delamination of the active material layer from the resin current collector for example, the softening temperature is preferably from 30° C. to 100° C., more preferably from 30° C. to 80° C., and even more preferably from 30° C. to 75° C.

The softening temperature of the resin refers to the glass transition temperature determined from a DSC curve obtained by differential scanning calorimetry (DSC).

Examples of the spherical carbon material include carbon materials where the ratio (hereinafter also called the “aspect ratio”) of the average length in one (e.g., the major axis) direction to the average length in the other (e.g., minor axis) direction is less than 5. That is, the scope of the spherical carbon material includes not only perfectly spherical carbon materials but also elliptical carbon materials. Examples of the spherical carbon material include: graphite such as natural graphite and artificial graphite; carbon black such as acetylene black (AB), Ketjenblack (KB), and furnace black; and amorphous carbon materials. One spherical carbon material may be used singly, or two or more spherical carbon materials may be used in combination. Among the above, the spherical carbon material preferably includes carbon black, and more preferably includes acetylene black (AB), from the standpoint of further curbing a reduction in discharge capacity due to delamination of the active material layer from the resin current collector.

The content of the spherical carbon material is, from the standpoint of further curbing a reduction in discharge capacity due to delamination of the active material layer from the resin current collector, preferably from 1% by mass to 20% by mass, more preferably from 1% by mass to 15% by mass, and even more preferably from 2% by mass to 13% by mass relative to the total solid content of the resin current collector.

From the standpoint of further curbing a reduction in discharge capacity due to delamination of the active material layer from the resin current collector, an aspect is preferred in which the spherical carbon material includes acetylene black (AB) and in which the content of the spherical carbon material is from 2% by mass to 13% by mass relative to the total solid content of the resin current collector.

Examples of the fibrous carbon material include fibrous carbon materials with an aspect ratio of 5 or higher (more preferably, 10 or higher). Examples of the fibrous carbon material include carbon nanotubes (CNT), carbon nanofibers (CNF), and vapor-grown carbon fibers (VGCF). One fibrous carbon material may be used singly, or two or more fibrous carbon materials may be used in combination. Among the above, the fibrous carbon material preferably includes vapor-grown carbon fibers (VGCF) from the standpoint of further curbing a reduction in discharge capacity due to delamination of the active material layer from the resin current collector.

The content of the fibrous carbon material is preferably from 10% by mass to 40% by mass, more preferably from 12% by mass to 30% by mass, and even more preferably from 15% by mass to 25% by mass relative to the total solid content of the resin current collector.

From the standpoint of further curbing a reduction in discharge capacity due to delamination of the active material layer from the resin current collector, an aspect is preferred in which the fibrous carbon material includes vapor-grown carbon fibers (VGCF) and in which the content of the fibrous carbon material is from 20% by mass to 43% by mass relative to the total solid content of the resin current collector.

The total content of the spherical carbon material and the fibrous carbon material is preferably from 10% by mass to 50% by mass, more preferably from 15% by mass to 43% by mass, and even more preferably from 15% by mass to 35% by mass relative to the total solid content of the resin current collector. Furthermore, the content ratio of the spherical carbon material and the fibrous carbon material is preferably from 1.0:1.0 to 1.0:10.0 and more preferably from 1.0:1.2 to 1.0:8.0.

The coefficient of linear thermal expansion of the resin current collector is preferably from 100×10⁻⁶ ppm/K to 500×10⁻⁶ ppm/K, more preferably from 200×10⁻⁶ ppm/K to 430×10⁻⁶ ppm/K, and even more preferably from 230×10⁻⁶ ppm/K to 350×10⁻⁶ ppm/K from the standpoint of further curbing a reduction in discharge capacity due to delamination of the active material layer from the resin current collector. The value of the coefficient of linear thermal expansion is a value as measured by a method compliant with JIS H 7404-1993.

The method used for providing a coefficient of linear thermal expansion of the resin current collector that is in the above range is not particularly limited, and examples thereof include a method that uses the aforementioned preferred resins for the resin in the resin current collector.

The thickness of the resin current collector is not particularly limited, but for example from the standpoint of further curbing a reduction in discharge capacity, the thickness of the resin current collector is preferably from 1 μm to 80 μm, more preferably from 1 μm to 50 μm, and even more preferably from 1 μm to 30 μm.

The thickness of the resin current collector is determined as follows. A layer-stack cross-section of the resin current collector cut in the thickness direction is observed using a scanning electron microscope (SEM) equipped with an energy dispersive X-ray spectrometer (EDX), thickness values are measured at ten freely-selected points in the cross-section, and the average value of the thickness values at the ten points is taken as the thickness of the resin current collector.

The method used for forming the resin current collector is not particularly limited, and examples thereof include: when the resin is a thermoplastic resin, a method including applying a coating liquid including the resin and the conductive material and drying the coating liquid, to form the resin current collector; and, when the resin is a thermosetting resin, a method including placing raw materials such as a resin precursor or a monomer along with the conductive material in a mold, followed by curing by heating.

The resin current collector may further include other materials in addition to the resin, the spherical carbon material, and the fibrous carbon material. Examples of those other materials include a conductive material other than the spherical carbon material and the fibrous carbon material, a binder, and a metal powder material.

### [Active Material Layer]

The active material layer includes an active material. The type of the active material is not particularly limited, and known materials for negative electrodes and positive electrodes can be applied.

The active material may include an Si-based active material.

Si-based active materials are useful active materials having excellent charge-discharge characteristics. However, Si-based active materials tend to undergo significant expansion and contraction in accompaniment with charging-discharging, so owing to this, the active material layer tends to delaminate from the current collector and the discharge capacity also tends to become lower. However, the solid-state battery according to the present disclosure includes the resin current collector including a spherical carbon material and a fibrous carbon material in addition to a resin. For that reason, compared with a case where the current collector is a metal foil, the resin current collector easily absorbs internal stress accompanying expansion of the electrode, and pressure acting on the solid-state battery is restricted. Furthermore, even when tiny cracks due to changes in volume occur in the active material layer provided on the current collector, a reduction in discharge capacity is curbed because the spherical carbon material and the fibrous carbon material connect conduction paths. This effect is more conspicuous when the active material includes an Si-based active material.

The Si-based active material is not particularly limited as long as it is a material that includes silicon and can act as an active material, and examples thereof include silicon simple substance particles, silicon alloy particles (e.g., alloys of Si and one or more metals selected from the group consisting of Sn, Ti, Fe, Ni, Cu, Co, and Al), porous silicon, silicon clathrate compounds, silicon oxides, and any mixture thereof. One Si-based active material may be used singly, or two or more Si-based active materials may be used in combination.

The active material layer may, as needed, further contain a solid-state electrolyte and a binder in addition to the active material.

The thickness of the active material layer is not particularly limited, but for example from the standpoint of imparting more excellent charge-discharge characteristics and the standpoint of further curbing a reduction in discharge capacity due to delamination of the active material layer from the resin current collector, the thickness of the active material layer is preferably from 0.1 μm to 100.0 μm, more preferably from 1.0 μm to 100.0 μm, and still more preferably from 30.0 μm to 100.0 μm.

The thickness of the active material layer is determined as follows. A layer-stack cross-section of the active material layer cut in the thickness direction is observed using a scanning electron microscope (SEM) equipped with an energy dispersive X-ray spectrometer (EDX), thickness values are measured at ten freely-selected points in the cross-section, and the average value of the thickness values at the ten points is taken as the thickness of the active material layer.

### [Intermediate Layer]

The specific electrode may further include an intermediate layer disposed between the active material layer and the resin current collector and in which at least one component included in the active material layer and at least one component included in the resin current collector are present in a mixed state.

When the specific electrode includes an intermediate layer, delamination of the active material layer from the resin current collector is further reduced.

The intermediate layer is, from the standpoint of enhancing the anchoring effect and further reducing delamination of the active material layer from the resin current collector, preferably a layer in which at least the active material included in the active material layer and the resin included in the resin current collector are present in a mixed state.

From the standpoint of enhancing the anchoring effect and further reducing delamination of the active material layer from the resin current collector, the ratio of the thickness of the intermediate layer to the thickness of the resin current collector (intermediate layer/resin current collector) is preferably from 1/30 to 1/6, more preferably from 1.0/30.0 to 1.0/4.0, still more preferably from 1.0/20.0 to 1.0/5.0, and even more preferably from 1.0/10.0 to 1.0/6.0.

The thickness of the intermediate layer is not particularly limited, but for example from the standpoint of giving it more excellent charge-discharge characteristics and further curbing a reduction in discharge capacity due to delamination of the active material layer from the resin current collector, it is preferably from 0.1 μm to 15.0 μm, more preferably from 0.4 μm to 10.0 μm, and even more preferably from 0.6 μm to 8.0 μm.

The thickness of the intermediate layer is determined as follows. A layer-stack cross-section of the intermediate layer cut in the thickness direction is observed using a scanning electron microscope (SEM) equipped with an energy dispersive X-ray spectrometer (EDX), thickness values are measured at ten freely-selected points in the cross-section, and the average value of the thickness values at the ten points is taken as the thickness of the intermediate layer.

The components included in the intermediate layer can be checked by an EDX analysis on the chemical composition of the layer-stack cross-section of the intermediate layer cut in the thickness direction, using a scanning electron microscope (SEM) equipped with an energy dispersive X-ray spectrometer (EDX).

The method used for forming the intermediate layer is not particularly limited, and examples thereof include: (1) when the resin in the resin current collector is a thermoplastic resin, a method including heating, to a temperature equal to or higher than the softening temperature of the thermoplastic resin, a layer stack in which the resin current collector including the thermoplastic resin (which may further include a conductive material) and the active material layer including the active material are stacked and pressing the layer stack, to form the intermediate layer; and, (2) when the resin in the resin current collector is a thermosetting resin, a method including filling a mold with a precursor of the thermosetting resin and components of the active material layer such as the active material and the binder, followed by heating, to form the intermediate layer.

### <Solid-State Electrolyte Layer>

The specific electrode preferably has a solid-state electrolyte layer. The solid-state electrolyte layer includes a solid-state electrolyte. The solid-state electrolyte preferably includes, from the standpoint of battery performance, at least one solid-state electrolyte species selected from the group consisting of a sulfide solid-state electrolyte, an oxide solid-state electrolyte, and a halide solid-state electrolyte, and more preferably includes a sulfide solid-state electrolyte.

The sulfide solid-state electrolyte preferably contains sulfur (S) as the main anion element, and, in addition to S, preferably also contains, for example, Li element and element A. The element A is at least one selected from the group consisting of P, As, Sb, Si, Ge, Sn, B, Al, Ga, and In. The sulfide solid-state electrolyte may further contain at least one of O or a halogen element. Examples of the halogen element (X) include F, Cl, Br, and I. The composition of the sulfide solid-state electrolyte is not particularly limited, and examples thereof include xLi₂S·(100−x)P₂S₅ (70≤x≤80) and yLiI·zLiBr·(100−y−z)(xLi₂S·(1−x)P₂S₅) (0.7≤x≤0.8, 0≤y≤30, 0≤z≤30). The sulfide solid-state electrolyte may have the composition represented by the following Formula (1).

Li₄₋ₓGe₁₋ₓPₓS₄ (0<x<1) Formula (1):

In Formula (1), at least part of Ge may be substituted with at least one selected from the group consisting of Sb, Si, Sn, B, Al, Ga, In, Ti, Zr, V, and Nb. Furthermore, at least part of P may be substituted with at least one selected from the group consisting of Sb, Si, Sn, B, Al, Ga, In, Ti, Zr, V, and Nb. Part of Li may be substituted with at least one selected from the group consisting of Na, K, Mg, Ca, and Zn. Part of S may be substituted with a halogen. The halogen is at least one of F, Cl, Br, or I.

The oxide solid-state electrolyte preferably contains oxygen (O) as the main anion element, and may for example contain Li, element Q (Q represents at least one of Nb, B, Al, Si, P, Ti, Zr, Mo, W, or S), and O. Examples of oxide solid-state electrolytes include garnet-type solid-state electrolytes, perovskite-type solid-state electrolytes, NASICON-type solid-state electrolytes, Li—P—O-based solid-state electrolytes, and Li—B—O-based solid-state electrolytes. Example of garnet-type solid-state electrolytes include Li₇La₃Zr₂O₁₂, Li₇₋ₓLa₃(Zr₂₋ₓNbₓ)O₁₂ (0≤x≤2), and Li₅La₃Nb₂O₁₂. Examples of perovskite-type solid-state electrolytes include (Li, La)TiO₃, (Li, La)NbO₃, and (Li, Sr)(Ta, Zr)O₃. Examples of NASICON-type solid-state electrolytes include Li(Al, Ti)(PO₄)₃ and Li(Al, Ga)(PO₄)₃. Examples of Li—P—O-based solid-state electrolytes include Li₃PO₄ and UPON (a compound obtained by replacing part of O in Li₃PO₄ by N), and examples of Li—B—O-based solid-state electrolytes include Li₃BO₃ and compounds obtained by replacing part of O in Li₃BO₃ by C.

As the halide solid-state electrolyte, a solid-state electrolyte including Li, M, and X (M represents at least one of Ti, Al, or Y, and X represents F, Cl, or Br) is preferred. Specifically, Li_{6-3z}Y_{z}X₆ (X represents Cl or Br, and z satisfies 0<z<2) and Li_{6-(4-x)b}(Ti₁₋ₓAlₓ)_{b}F₆ (0<x<1, 0<b≤1.5) are preferred. Among Li_{6-3z}Y_{z}X₆, in terms of having excellent lithium ion conductivity, Li₃YX₆ (X represents Cl or Br) is more preferred, and Li₃YCl₆ is even more preferred. Furthermore, it is preferred that Li_{6-(4-x)b}(Ti₁₋ₓAlₓ)_{b}F₆ (0<x<1, 0<b≤1.5) be included together with a solid-state electrolyte such as a sulfide solid-state electrolyte from for example the standpoint of inhibiting oxidative decomposition of the sulfide solid-state electrolyte.

### <Applications>

The solid-state battery of the present disclosure is a typical solid-state secondary battery (more preferably, a solid-state lithium-ion secondary battery). Examples of applications of the solid-state battery include power sources for vehicles, electronic devices, and electricity storages. Examples of vehicles include four-wheeled electric vehicles, two-wheeled electric vehicles, gasoline automobiles, and diesel automobiles. Examples of four-wheeled electric vehicles include battery electric vehicles (BEV), plug-in hybrid electric vehicles (PHEV), and hybrid electric vehicles (HEV). Among these, the solid-state battery of the present disclosure is preferably applied as a power source for driving a hybrid electric vehicle, a plug-in hybrid electric vehicle, or a battery electric vehicle.

### EXAMPLES

### Example 1

### [Preparation of Positive Electrode]

A positive electrode slurry was prepared by using an ultrasonic dispersing device to stir a positive electrode mix including an NCA positive electrode active material (LiNi_{0.8}Co_{0.15}Al_{0.05}O₂), a sulfide-based solid-state electrolyte (Li₂S—P₂S₅), a conductive material (VGCF), a PVDF-based binder, and butyl butyrate as raw materials. Here, the mass ratio of the NCA positive electrode active material:the sulfide-based solid-state electrolyte:the vapor-grown carbon fiber:the PVDF-based binder in the positive electrode slurry was adjusted to 88.2:9.8:1.3:0.7. The positive electrode slurry was coated by a blade coating method onto an Al foil and a SUS foil, and these were dried at 100° C. on a hot plate for 30 minutes to obtain two positive electrodes having a positive electrode active material layer.

### [Preparation of Negative Electrode]

A negative electrode slurry was prepared by using an ultrasonic dispersing device to stir a negative electrode mix including powder Si particles (Si-based negative electrode active material), a sulfide-based solid-state electrolyte (Li₂S—P₂S₅), a conductive material (VGCF), a PVDF-based binder, and butyl butyrate as raw materials. Here, the mass ratio of the powder Si particles:the sulfide-based solid-state electrolyte:the carbon material:the PVDF-based binder in the negative electrode slurry was adjusted to 100:77.6:2:15. The negative electrode slurry was coated by a blade coating method onto a Ni foil and a SUS foil, and these were dried at 100° C. on a hot plate for 30 minutes to obtain two negative electrodes having a negative electrode active material layer.

### [Preparation of Solid-State Electrolyte Layer]

A solid-state electrolyte slurry was prepared by using an ultrasonic dispersing device to stir a solid-state electrolyte mix including a sulfide-based solid-state electrolyte (Li₂S—P₂S₅), a PVDF-based binder, and butyl butyrate as raw materials. Here, the mass ratio of the sulfide-based solid-state electrolyte:the PVDF-based binder in the solid-state electrolyte slurry was adjusted to 99.4:0.4. The solid-state electrolyte slurry was coated by a blade coating method onto the positive electrode active material layers of the two positive electrodes prepared as described above to obtain a layer stack of the solid-state electrolyte layer/the positive electrode active material layer/the Al foil (i.e., solid-state electrolyte layer/positive electrode) and a layer stack of the solid-state electrolyte layer/the positive electrode active material layer/the SUS foil (i.e., solid-state electrolyte layer/positive electrode).

### [Preparation of Resin Current Collector]

A conductive paste obtained by mixing a spherical carbon material (AB, with an aspect ratio of from 1 to 5) of the type and amount shown in Table 1, a fibrous carbon material (VGCF, with an aspect ratio of from 10 to 500) of the type and amount shown in Table 1, polymethyl methacrylate (amorphous resin) as a resin, and butyl butyrate was coated by a blade coating method onto a PET film and dried at 150° C. for 30 minutes, and then the PET film was peeled away to obtain a resin current collector. It will be noted that the glass transition temperature (i.e., the softening temperature) of the resin was equal to or lower than the crystallization temperature of the solid-state electrolyte.

### [Preparation of Stacked Body]

The two types of positive electrode/solid-state electrolyte layer stack structures and the two types of negative electrodes prepared as described above were layered in the following combinations to obtain two sub-stacked bodies.
Ni foil/negative electrode active material layer/solid-state electrolyte layer/positive electrode active material layer/SUS foil
SUS foil/negative electrode active material layer/solid-state electrolyte layer/positive electrode active material layer/Al foil

Next, the two sub-stacked bodies were individually pressed in a roll press machine at a pressing pressure of 50 kN/cm and a temperature of 160° C. Then, the SUS foils were peeled away from the sub-stacked bodies, and the resin current collector was disposed between the sub-stacked bodies, from which the SUS foils had been peeled away, and incorporated into the stack structure, to obtain a stacked body having a “Ni foil/negative electrode active material layer/solid-state electrolyte layer/positive electrode active material layer/resin current collector/negative electrode active material layer/solid-state electrolyte layer/positive electrode active material layer/Al foil” layer-stack structure. Thereafter, this stacked body was pressed in a roll press machine at a pressing pressure of 20 kN/cm and a temperature of 160° C. Next, the stacked body was punched to a size of 1 cm² to obtain a solid-state battery having a “Ni foil/negative electrode active material layer/solid-state electrolyte layer/positive electrode active material layer/intermediate layer/resin current collector/intermediate layer/negative electrode active material layer/solid-state electrolyte layer/positive electrode active material layer/Al foil” layer-stack structure.

### Example 2 to Example 4

Resin current collectors were obtained using the same specifications as in Example 1 except that in the preparation of the resin current collectors the amounts of the spherical carbon material and the fibrous carbon material were set to the specifications shown in Table 1. Solid-state batteries were obtained using the same specifications as in Example 1 except that the obtained resin current collectors were used.

### Comparative Example 1

### [Preparation of Positive Electrode]

A positive electrode slurry was prepared by using an ultrasonic dispersing device to stir a positive electrode mix including an NCA positive electrode active material (LiNi_{0.8}Co_{0.15}Al_{0.05}O₅O₂), a sulfide-based solid-state electrolyte (Li₂S—P₂S₅), a conductive material (VGCF), a PVDF-based binder, and butyl butyrate as raw materials. Here, the mass ratio of the NCA positive electrode active material:the sulfide-based solid-state electrolyte:the vapor-grown carbon fiber:the PVDF-based binder in the positive electrode slurry was adjusted to 88.2:9.8:1.3:0.7. The positive electrode slurry was coated by a blade coating method onto an Al foil, and this was dried at 100° C. on a hot plate for 30 minutes to obtain one positive electrode having a positive electrode active material layer.

### [Preparation of Negative Electrode]

A negative electrode slurry was prepared by using an ultrasonic dispersing device to stir a negative electrode mix including powder Si particles, a sulfide-based solid-state electrolyte (Li₂S—P₂S₅), a conductive material (VGCF), a PVDF-based binder, and butyl butyrate as raw materials. Here, the mass ratio of the powder Si particles:the sulfide-based solid-state electrolyte:the carbon material:the PVDF-based binder in the negative electrode slurry was adjusted to 100:77.6:2:15. The negative electrode slurry was coated by a blade coating method onto a Ni foil, and this was dried at 100° C. on a hot plate for 30 minutes to obtain one negative electrode having a negative electrode active material layer.

### [Preparation of Solid-state Electrolyte Layer]

A solid-state electrolyte slurry was prepared by using an ultrasonic dispersing device to stir a solid-state electrolyte mix including a sulfide-based solid-state electrolyte (Li₂S—P₂S₅), a PVDF-based binder, and butyl butyrate as raw materials. Here, the mass ratio of the sulfide-based solid-state electrolyte:the PVDF-based binder in the solid-state electrolyte slurry was adjusted to 99.4:0.4. The solid-state electrolyte slurry was coated by a blade coating method onto the positive electrode active material layer of the positive electrode prepared as described above to obtain a layer stack of the solid-state electrolyte layer/the positive electrode active material layer/the Al foil (i.e., solid-state electrolyte layer/positive electrode).

### [Preparation of Stacked Body]

The one type of positive electrode/solid-state electrolyte layer stack structure and the one type of negative electrode prepared as described above were layered in the following combination to obtain one stacked body.
Ni foil/negative electrode active material layer/solid-state electrolyte layer/positive electrode active material layer/Al foil

Next, the stacked body was pressed in a roll press machine at a pressing pressure of 50 kN/cm and a temperature of 160° C. Next, the stacked body was punched to a size of 1 cm² to obtain a solid-state battery having a “Ni foil/negative electrode active material layer/solid-state electrolyte layer/positive electrode active material layer/Al foil” layer-stack structure.

### <Evaluation of Confining Pressure at Charging>

Each of the solid-state batteries of Example 1 and Comparative Example 1 was sandwiched between two confining plates, and the two confining plates were tightened with a fastener at a confining pressure of 5 MPa to fix the distance between the two confining plates. Next, the confined stacked bodies were charged with a constant current of 1/10 C to 8.10 V and thereafter charged with a constant voltage of 8.10 V to a final current of 1/100 C. The confining pressures before the start of charging and at the end of charging were recorded. Values obtained by dividing the absolute value of the difference (P_{BEFORE}−P_{AFTER}) between the confining pressure P_{BEFORE} before the start of charging and the confining pressure P_{AFTER} at the end of charging by the discharge capacity were used as confining pressure change indices. The larger the confining pressure change index is, the larger the expansion of the solid-state battery accompanying charging is.

FIG. 2 is a graph showing the relationship between the confining pressure change indices and the charging amounts in Example 1 and Comparative Example 1. As shown in FIG. 2, change in the confining pressure accompanying charging was reduced in the solid-state battery of Example 1 compared with the solid-state battery of Comparative Example 1.

### <Evaluation of Discharge Capacity>

Using a galvanostat, a charge-discharge test was implemented for 50 cycles under the conditions of a current of 0.1 C, an end-of-charge voltage of 8.10 V, and an end-of-discharge voltage of 5.0 V. Each cycle starts with charging, and after one charging process was completed, the discharge capacity in each cycle was calculated by determining the amount of current generated during discharging to 5.0 V and dividing the amount of current by the weight of the active material used for the measurement. Then, the discharge capacity in the 150th cycle was divided by the discharge capacity in the first cycle to obtain the capacity retention rate (%) after 150 cycles. The results are shown in Table 1.

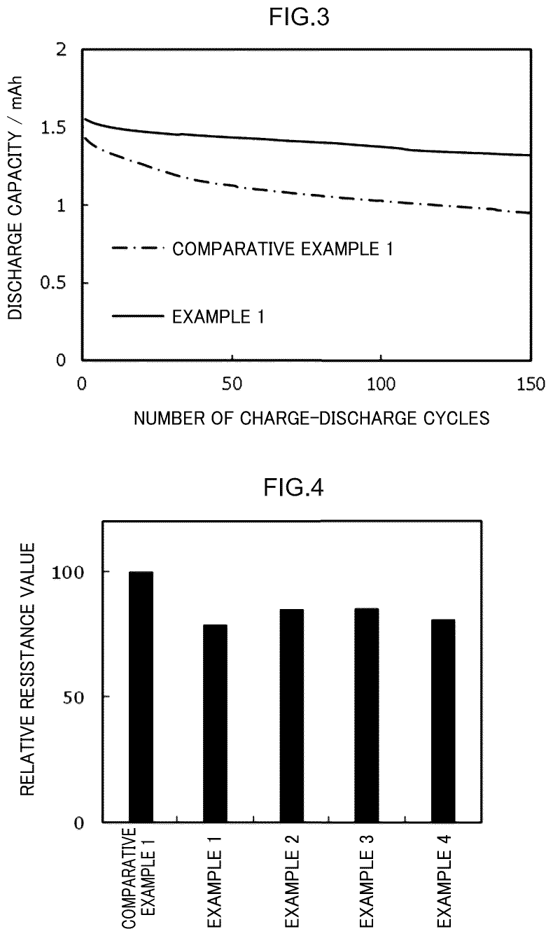

FIG. 3 is a graph showing the relationship between the discharge capacity and the number of charge-discharge cycles in Example 1 and Comparative Example 1. As shown in FIG. 3, it was found that, compared with the solid-state battery of Comparative Example 1, the solid-state battery of Example 1 had an excellent capacity retention rate, that is, a reduction in discharge capacity was curbed.

### <Evaluation of Resistance Values>

Each of the solid-state batteries of Examples 1 to 4 and Comparative Example 1 was sandwiched between two confining plates, and the two confining plates were tightened with a fastener at a confining pressure of 5 MPa to fix the distance between the two confining plates. Next, the confined stacked bodies were charged with a constant current of 1/10 C to 8.10 V and thereafter charged with a constant voltage of 8.10 V to a final current of 1/100 C. Moreover, the stacked bodies were discharged with a constant current of 1/10 C to 5.0 V and thereafter discharged with a constant voltage of 5.0 V to a final current of 1/100 C. Then, resistance values were calculated by dividing the absolute value of the difference between the voltage before charging and the voltage at 0.1 seconds after discharging by a current corresponding to 1/100 C. The obtained resistance values are shown in FIG. 4 as relative values relative to the resistance value of the solid-state battery of Comparative Example 1.

FIG. 4 is a graph showing the relative resistance values of the solid-state batteries of Examples 1 to 4 and Comparative Example 1. As shown in FIG. 4, it was found that, compared with the solid-state battery of Comparative Example 1, an increase in the resistance value due to delamination of the active material layer from the current collector was curbed in the solid-state batteries of the Examples.

TABLE 1

| | Resin Current Collector | | | | | |
|---|---|---|---|---|---|---|
| | | | | | | Thickness of Intermediate |
| | | | | | | Layer (μm) |
| | Amount | Amount | Amount | Amount of VGCF | Amount of AB | Between Positive |
| | of VGCF | of AB | of Resin | relative to | relative to | Electrode Active |
| | (parts | (parts | (parts | Current Collector | Current Collector | Material Layer and Resin |
| | by mass) | by mass) | by mass) | (% by mass) | (% by mass) | Current Collector |
| Example 1 | 4.0 | 0.6 | 16 | 19 | 3 | 2.2 |
| Example 2 | 4.0 | 1.2 | 16 | 19 | 6 | 2.1 |
| Example 3 | 4.0 | 1.8 | 16 | 18 | 8 | 1.8 |
| Example 4 | 4.0 | 2.4 | 16 | 18 | 11 | 1.5 |
| Comparative | 0.0 | 0.0 | 0 | — | — | — |
| Example 1 | | | | | | |

| | Resin Current Collector | | | | |
|---|---|---|---|---|---|
| | Thickness of Intermediate | | | | |
| | Layer (μm) | Thickness | | | |
| | Between Resin | Ratio | Linear | | |
| | Current Collector | (Intermediate | Thermal | | Capacity |
| | and Negative | Layer/Resin | Expansion | Press | Retention |
| | Electrode Active | Current | Coefficient | Temperature | Rate |
| | Material Layer | Collector) | (ppm/K) | (° C.) | (%) |
| Example 1 | 2.3 | 1.0/6.0 | 285 × 10⁻⁶ | 160 | 93 |
| Example 2 | 2.0 | 1.0/6.8 | 270 × 10⁻⁶ | 160 | 84 |
| Example 3 | 2.0 | 1.0/7.1 | 250 × 10⁻⁶ | 160 | 83 |
| Example 4 | 1.7 | 1.0/8.0 | 240 × 10⁻⁶ | 160 | 82 |
| Comparative | — | — | — | 160 | 79 |
| Example 1 | | | | | |

As shown in Table 1, it was found that, compared with the solid-state battery of the Comparative Example, the solid-state batteries of the Examples had an excellent capacity retention rate, that is, a reduction in discharge capacity was curbed.

In FIG. 1, the reference characters respectively represent the following elements.
A: negative electrode active material layer A
B: solid-state electrolyte layer B
C: positive electrode active material layer C
101: negative electrode active material
102: solid-state electrolyte
103: positive electrode active material
105 and 107: conductive aid
109 and 111: binder
113: negative electrode current collector
115: positive electrode current collector

What is claimed is:

1. A solid-state battery, comprising an electrode,
the electrode comprising:
a resin current collector including a resin, a spherical carbon material, and a fibrous carbon material; and
an active material layer including an active material.

2. The solid-state battery according to claim 1, wherein the active material includes an Si-based active material.

3. The solid-state battery according to claim 1, wherein the softening temperature of the resin is from 30° C. to 80° C.

4. The solid-state battery according to claim 1, wherein the spherical carbon material includes acetylene black (AB), and a content of the spherical carbon material is from 2% by mass to 13% by mass relative to a total solid content of the resin current collector.

5. The solid-state battery according to claim 1, wherein the fibrous carbon material includes vapor-grown carbon fiber (VGCF), and a content of the fibrous carbon material is from 15% by mass to 25% by mass relative to a total solid content of the resin current collector.
